(19) United States
(12) Patent Application Publication
(10) Pub. No.: US 2004/0186236 A1
(43) Pub. Date: Sep. 23, 2004

(54) Process for producing thermoplastic elastomer composition

(75) Inventors: Noboru Komine, Chiba-shi (JP); Akio Okada, Sodegaura-shi (JP); Masafumi Kimura, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/799,772

(22) Filed: Mar. 15, 2004

(30) Foreign Application Priority Data
Mar. 17, 2003 (JP) 2003-071635

(51) Int. Cl. C08F 8/00

(52) U.S. Cl. 525/192; 525/240

(57) ABSTRACT

A process for producing a thermoplastic elastomer composition comprising the step of feeding bulky rubber, a thermoplastic resin and an additive to an extruder, and then melt kneading the bulky rubber, the thermoplastic resin and the additive in the extruder, wherein the feeding amount of the bulky rubber is controlled by a method comprising the steps of:

(1) measuring the amount of the produced thermoplastic elastomer composition at an outlet of the extruder,

(2) calculating the feeding amount of the bulky rubber by deducting the feeding amount of the thermoplastic resin and the additive from the amount of the produced thermoplastic elastomer composition measured in the step (1), and

(3) controlling the feeding amount of the bulky rubber based upon the feeding amount of the bulky rubber calculated in the step (2).

### FIELD OF THE INVENTION

The present invention relates to a process for producing a thermoplastic elastomer composition.

### BACKGROUND OF THE INVENTION

As a method for feeding bulky rubber to an extruder through a rubber feeder in a process for producing a thermoplastic elastomer composition using the bulky rubber, there is known a method for feeding the bulky rubber to clearance between two screws rotating in counter directions from each other in the rubber feeder, wherein the bulky rubber has a shape nearly similar to a rectangular parallelepiped shape, and length of at least one side among three sides thereof is shorter than length of the clearance (U.S. Pat. No. 6,399,709 and JP 2000-43032A).

### SUMMARY OF THE INVENTION

However, in the above-mentioned process for producing a thermoplastic elastomer composition, the size of the bulky rubber and the size of the screws in the rubber feeder are restricted, and as a result, the above-mentioned process has the following problems:

(1) the bulky rubber must be cut beforehand to pieces having the above-mentioned specified size,

(2) the rubber feeder having the above-mentioned specified structure must be used, and

(3) when using the bulky rubber having an indefinite shape, accuracy of the feeding amount thereof to the extruder is deteriorated.

An object of the present invention is to provide a process for producing a thermoplastic elastomer composition, wherein variation of the feeding amount of bulky rubber to an extruder is small, even if the shape or size of the bulky rubber changes, and therefore, the bulky rubber can be fed stably to the extruder.

The present invention is a process for producing a thermoplastic elastomer composition comprising the step of feeding bulky rubber, a thermoplastic resin and an additive to an extruder, and then melt kneading the bulky rubber, the thermoplastic resin and the additive in the extruder, wherein the feeding amount of the bulky rubber is controlled by a method comprising the steps of:

(1) measuring the amount of the produced thermoplastic elastomer composition at an outlet of the extruder,

(2) calculating the feeding amount of the bulky rubber by deducting the feeding amount of the thermoplastic resin and the additive from the amount of the produced thermoplastic elastomer composition measured in the step (1), and

(3) controlling the feeding amount of the bulky rubber based upon the feeding amount of the bulky rubber calculated in the step (2).

### BRIEF DESCRIPTION OF THE DRAWINGS

FIG. 1, which is given by way of illustration only, and thus is not limitative of the present invention, shows an example of an extruder, and a method for controlling the feeding amount of bulky rubber in the present invention, wherein: 1 - - - rubber crusher, 2 - - - twin screw extruder, 3 - - - pressure sensor, 4 - - - rubber-feeding pressure controller, 5 - - - gear pump, 6 - - - thermoplastic resin feeder, 7 - - - additive feeder, 8 - - - crosslinking agent feeder, 9 - - - outlet for thermoplastic elastomer composition, 10 - - - measuring tool, 11 - - - controlling system, and 12 - - - extruder.

### DETAILED DESCRIPTION OF THE INVENTION

Examples of a feeder for feeding the bulky rubber to the extruder in the present invention are a feeder such as a screw conveyor-type feeder and a belt conveyor-type feeder; an extruder such as a single screw extruder and a twin screw extruder; and a gear pump. Two or more of these apparatuses may be combined with each other. Among them, particularly preferred is a combination of an extruder with a gear pump. A screw revolution of an extruder can easily be controlled in response to pressure of a feeding side of a gear pump. Said combination can make constant pressure of the bulky rubber conveyed from an extruder to a gear pump, and as a result, the bulky rubber can be fed very stably. Examples of the extruder are a single screw extruder, a twin screw extruder and a twin screw extruder combined with a single screw. The twin screw extruder combined with a single screw means an extruder (i) having two screws situated in the upper part of the extruder, which revolve in counter directions from each other, and (ii) having one screw situated in the lower part of the extruder. Said two screws thereof may be arranged either on a parallel with each other, or obliquely such as two screws situated in a conical twin screw extruder.

When the feeding amount of the bulky rubber to the extruder changes because of its non-uniform shape, a screw revolution of a rubber feeder is controlled by feeding back of the feeding amount of the bulky rubber to the feeding step of the bulky rubber, said feeding amount being calculated by the steps in the present invention, whereby the predetermined amount of the bulky rubber can be fed.

Examples of the extruder used in the present invention are a single screw extruder, a twin screw extruder and a multi screw extruder having three or more screws, each of which extruders is equipped with one or more screws or rotors having kneading ability.

In the present invention, it is preferable to feed the bulky rubber to an inlet situated in the upper part of the extruder, and feed the thermoplastic resin and the additive to an inlet situated in the lower part of the extruder.

The bulky rubber used in the present invention is not limited in its shape. Examples thereof are a sphere-shaped rubber, a column-shaped rubber, a rectangular parallelepiped-shaped rubber, a flake-shaped rubber, a crumb-shaped rubber (crumb rubber) and a thread-shaped rubber.

Examples of a method for obtaining the bulky rubber are (1) a method of crushing bale shaped rubber with a rubber crusher, (2) a method of cutting bale shaped rubber with a rubber cutter, and (3) a method of obtaining the bulky rubber (crumb rubber) by a process comprising the steps of (i) removing a catalyst residue from a polymerization mixture containing rubber, and then (ii) drying.

The thermoplastic resin and the additive used in the present invention are fed to an extruder with a weighing feeder or a volumetric feeder. Since each of these components has a uniform shape such as a pellet, granule and powder, its feeding amount hardly changes. In order to feed them more stably, it is preferable to use a weighing feeder.

Examples of the additive are antioxidants, weatherability stabilizers, antistatic agents, slipping agents, crosslinking agents, crosslinking coagents, coloring pigments, inorganic fillers and mineral oil.

An example of a measuring tool for measuring a mass of a produced thermoplastic elastomer composition at an outlet of the extruder is a measuring tool having a container (its weight=W₁), wherein the weight of the thermoplastic elastomer composition (W) is measured by a method comprising the steps of (i) catching the thermoplastic elastomer composition in the container for a predetermined time, (ii) measuring its weight (W₂), and (iii) obtaining the weight of the thermoplastic elastomer composition (W) contained in the container by calculating the formula, W=W₂−W₁.

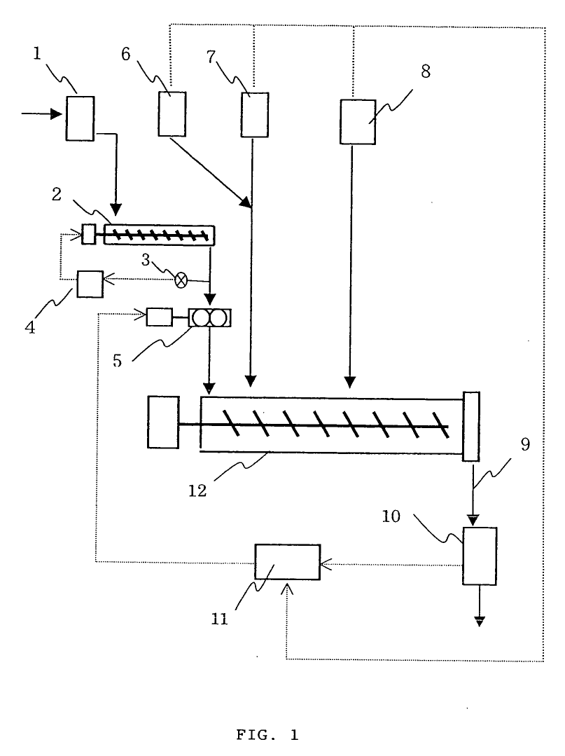

The feeding amount of the bulky rubber can be controlled, for example, by adjusting revolution of a screw or a gear in a rubber feeder. A specific example of the controlling method is shown in FIG. 1, wherein the method comprises the steps of (i) inputting the feeding amount of each of the starting components in the controlling system (CS) 11, (ii) conveying information of the thermoplastic resin feeder 6, the additive feeder 7, the crosslinking agent feeder 8 and the measuring tool 10 to the controlling system (CS) 11, (iii) operating, and (iv) controlling the feeding amount of the gear pump 5.

The bulky rubber used in the present invention is not particularly limited in its kind, and may be a commercially available one. As the rubber, preferred is an ethylene-α-olefin copolymer rubber (hereinafter, referred to as “copolymer rubber 1”) such as an ethylene-propylene copolymer rubber and an ethylene-1-butene copolymer rubber; an ethylene-α-olefin-non-conjugated diene copolymer rubber (hereinafter, referred to as “copolymer rubber 2”) such as an ethylene-propylene-5-ethylidene-2-norbornene copolymer rubber and an ethylene-propylene-dicyclopentadiene copolymer rubber; or their combination. Each of these rubbers may be a combination with an extender oil, namely, an oil-extended rubber. Hereinafter, the copolymer rubber 1 and the copolymer rubber 2 are collectively referred to as “copolymer rubber”.

As the α-olefin in the above-mentioned copolymer rubber, preferred is an α-olefin having from 3 to 20 carbon atoms. Examples of the α-olefin are propylene, 1-butene, 1-pentene, 1-hexene, 4-methyl-1-pentene, 1-octene and 1-decene. Among them, preferred is propylene, 1-butene, 1-hexene or 1-octene. A content of an α-olefin unit contained in the above-mentioned copolymer rubber 1, copolymer rubber 2 or their combination is from 10 to 55% by weight, and preferably from 20 to 40% by weight, wherein the weight of the copolymer rubber 1, the copolymer rubber 2 or their combination is 100% by weight. Here, a monomer unit such as the above-mentioned “α-olefin unit” means a polymerized monomer unit.

As the non-conjugated diene in the above-mentioned copolymer rubber 2, preferred is a non-conjugated diene having from 5 to 20 carbon atoms. Examples of the non-conjugated diene are a chain non-conjugated diene such as 1,4-hexadiene, 1,6-octadiene, 2-methyl-1,5-hexadiene, 6-methyl-1,5-heptediene and 7-methyl-1,6-octadiene; a cyclic non-conjugated diene such as cyclohexadiene, dicyclopentadiene, methyltetrahydroindene, 5-vinylnorbornene, 5-ethylidene-2-norbornene, 5-methylene-2-norbornene, 5-isopropylidene-2-norbornene and 6-chloromethyl-5-isopropenyl-2-norbornene; and 2,3-diisopropylidene-5-norbornene, 2-ethylidene-3-isopropylidene-5-norbornene, 2-propenyl-2,2-norbornadiene, 1,3,7-octatriene and 1,4,9-decatriene. Among them, preferred is 5-ethylidene-2-norbornene or dicyclopentadiene.

Mooney viscosity (ML₁₊₄ 100° C.) of the above-mentioned copolymer rubber is preferably from 30 to 350, and more preferably from 120 to 350. When the Mooney viscosity is lower than 30, the obtained thermoplastic elastomer composition may be remarkably deteriorated in its mechanical strength. When the Mooney viscosity exceeds 350, the obtained thermoplastic elastomer composition may be deteriorated in appearance of its molded article. When using the above-mentioned oil-extended rubber, the Mooney viscosity means that of the oil-extended rubber.

The thermoplastic resin used in the present invention means a resin, which can produce a thermoplastic elastomer composition by melt kneading together with the above-mentioned rubber. The thermoplastic resin may be a commercially available resin, and may be a combination of two or more resins. Among them, preferred is an olefin polymer resin obtained by polymerizing at least one olefin. Examples of the olefin polymer resin are an ethylene homopolymer; an α-olefin homopolymer such as a propylene homopolymer; an ethylene-α-olefin copolymer such as an ethylene-1-butene copolymer; a copolymer containing a propylene unit such as a propylene-ethylene copolymer, a propylene-1-butene copolymer and a propylene-ethylene-1-butene copolymer; and an ethylene-based copolymer such as an ethylene-vinyl acetate copolymer and an ethylene-methyl methacylate copolymer.

As the olefin polymer resin, preferred is an isotactic crystallinity-carrying and propylene unit-containing resin such as a propylene homopolymer, a propylene-ethylene copolymer, a propylene-α-olefin copolymer and a propylene-ethylene-α-olefin copolymer. These copolymers may be either random copolymers or block copolymers. A melt flow rate of these propylene unit-containing resins measured at 230° C. under 21.18 N is preferably from 0.1 to 100 g/10 minutes.

A process for producing the thermoplastic resin used in the present invention is not particularly limited, and may be a process known in the art. A catalyst used in the process is not also particularly limited. Examples of the catalyst are a multi-site catalyst such as a conventional solid catalyst and a single-site catalyst (for example, a catalyst obtained using a metallocene complex).

A blending ratio of the bulky rubber to the thermoplastic resin is preferably 15-95/85-5 parts by weight, wherein the total amount of the both components is 100 parts by weight. When producing a crosslinked thermoplastic elastomer composition, said ratio is 35-90/65-10, and preferably 60-90/40-10. When producing a non-crosslinked thermoplastic elastomer composition, said ratio is 15-80/85-20, and preferably 15-50/85-50. When using the above-mentioned oil-extended rubber, the rubber in the above-mentioned ratio means the oil-extended rubber.

In case of producing a crosslinked thermoplastic elastomer composition, an organic peroxide is generally used as a crosslinking agent. Examples of the organic peroxide are 2,5-dimethyl-2,5-di(t-butylperoxy)hexane, 2,5-dimethyl-2,5-di(t-butylperoxy)hexyne-3,1,3-bis(t-butylperoxyisopropyl)benzene, 1,1-di(t-butylperoxy)3,5,5-trimethylcyclohexane, 2,5-dimethyl-2,5-di(peroxybenzoyl)hexyne-3 and dicumyl peroxide. Among them, particularly preferred is 2,5-dimethyl-2,5-di(t-butylperoxy)hexane in view of stench and scorch.

The organic peroxide is added in an amount of from 0.005 to 2.0 parts by weight, and preferably from 0.01 to 0.6 part by weight, wherein the total amount of the bulky rubber and the thermoplastic resin is 100 parts by weight. When the amount is less than 0.005 part by weight, an effect of the crosslinking reaction is small. When the amount exceeds 2.0 parts by weight, it is difficult to control the crosslinking reaction, and further, use of such an excess amount is not economical. The organic peroxide may be combined with a liquid or powdery diluent. Examples of the diluent are oil, organic solvents and inorganic fillers such as silica and talc.

The crosslinking agent such as the above-mentioned organic peroxide may be combined with a crosslinking coagent, whereby a homogeneous and mild crosslinking reaction, and a preferable reaction between the bulky rubber and the thermoplastic resin can be carried out, and as a result, there can be obtained a thermoplastic elastomer composition having improved mechanical characteristics.

An example of the above-mentioned crosslinking coagent is a poly-functional compound such as N,N′-m-phenylenebismaleimide, toluylenebismaleimide, p-quinonedioxime, nitrobenzene, diphenylguanidine, trimethylolpropane, divinylbenzene, ethylene glycol dimethacrylate, polyethylene glycol dimethacrylate, trimethylolpropane trimethacrylate and allyl methacrylate.

The crosslinking coagent is added in an amount of from 0.01 to 4.0 parts by weight, and preferably from 0.05 to 2.0 parts by weight, wherein the total amount of the bulky rubber and the thermoplastic resin is 100 parts by weight. When the amount is less than 0.01 part by weight, an adding effect of the crosslinking coagent can hardly be found, and it is not economical to add the crosslinking coagent in an amount of more than 4.0 parts by weight.

### EXAMPLE

The present invention is explained with reference to the following Example, which is not intended to limit the scope of the present invention.

The apparatuses and components used in the following Example were as follows.

1. Rubber Crusher

As a rubber crusher, there was used a rubber cutter manufactured by NETZSCH-CONDUX Mahltechnik GmbH.

2. Rubber-Feeding Apparatus

As the rubber-feeding apparatus, there was used a rubber-feeding apparatus composed of (i) an extruder having a trade name of TEX 44, and (ii) a gear pump, both of which are manufactured by the Japan Steel Works, Ltd.

3. Extruder

As the extruder, there was used an extruder having a trade name of TEX 44 manufactured by the Japan Steel Works, Ltd.

4. Mass Measuring Tool

As the mass measuring tool, there was used a measuring tool manufactured by K-Tron International, Inc.

5. Rubber

As the rubber, there was used an oil-extended ethylene-propylene-5-ethylidene-2-norbornene copolymer rubber (trade name of ESPRENE 670F) manufactured by Sumitomo Chemical Company Limited, which rubber has a Mooney viscosity (ML₁₊₄100° C.) of 63 measured according to ASTM D-927-57T.

6. Thermoplastic Resin

As the thermoplastic resin, there was used a polypropylene resin (trade name of NOBLENE Y501N) manufactured by Sumitomo Chemical Company Limited, which resin has a MFR (melt flow rate) of 13 g/10 minutes measured according to JIS K6758 at 230° C. under a load of 21.18 N.

7. Additive

As the additive, there was used a mixture of 0.9 part by weight of a crosslinking coagent (trade name of SUMIFINE BM) manufactured by Sumitomo Chemical Company Limited, and 0.25 part by weight of an antioxidant (trade name of SUMILIZER BP101) manufactured thereby.

8. Crosslinking Agent

As the crosslinking agent additive, there was used a 10% by weight concentration-solution of 2,5-dimethyl-2,5-di(t-butylperoxy)hexane in mineral oil (trade name of DIANA PROCESS OIL PW380) manufactured by Idemitsu Kosan Co., Ltd.

### Example 1

The rubber was crushed with the rubber crusher 1 as shown in FIG. 1 to obtain indefinite shape-carrying bulky rubber having a size of from 1 to 4 cm. The obtained bulky rubber was fed continuously, through the gear pump 5, to the extruder 12 with the twin screw extruder 2, wherein the feeding pressure of the bulky rubber at the inlet of the gear pump 5 was measured with the pressure sensor 3 of the rubber-feeding pressure controller 4, and the screw-revolution of the twin screw extruder 2 was changed depending upon the measured feeding pressure in order to keep the feeding pressure constant.

The thermoplastic resin, the additive and the crosslinking agent were fed continuously to the extruder 12, with the thermoplastic resin feeder 6 (weighing feeder), the additive feeder 7 (weighing feeder) and the crosslinking agent feeder 8 (plunger pump), respectively, at the feeding rate of 4 kg/hour, 0.35 kg/hour and 1 kg/hour, respectively. These three components were dynamically crosslinked by melt kneading them in the extruder 12, thereby obtaining the crosslinked thermoplastic elastomer composition discharged from the outlet of the thermoplastic elastomer composition 9.

Based upon the amount of the thermoplastic elastomer composition measured with the measuring tool 10, the feeding amount of the thermoplastic resin, the feeding amount of the additive, and the feeding amount of the crosslinking agent, there were calculated the production amount of the thermoplastic elastomer composition of 31.4 kg/hour, and the feeding amount of the bulky rubber of 26 kg/hour, with the controlling system 11. Based upon the calculated amounts, the gear revolution of the gear pump 5 was controlled.

The bulky rubber was fed stably to the extruder 12, and the thermoplastic elastomer composition was produced smoothly.

1. A process for producing a thermoplastic elastomer composition comprising the step of feeding bulky rubber, a thermoplastic resin and an additive to an extruder, and then melt kneading the bulky rubber, the thermoplastic resin and the additive in the extruder, wherein the feeding amount of the bulky rubber is controlled by a method comprising the steps of:
(1) measuring the amount of the produced thermoplastic elastomer composition at an outlet of the extruder,
(2) calculating the feeding amount of the bulky rubber by deducting the feeding amount of the thermoplastic resin and the additive from the amount of the produced thermoplastic elastomer composition measured in the step (1), and
(3) controlling the feeding amount of the bulky rubber based upon the feeding amount of the bulky rubber calculated in the step (2).

2. The process for producing a thermoplastic elastomer composition according to claim 1, wherein the bulky rubber is fed to an extruder through a rubber feeder combined with a screw extruder and a gear pump.

3. The process for producing a thermoplastic elastomer composition according to claim 2, wherein the bulky rubber is fed to a gear pump under a constant feeding pressure.

4. The process for producing a thermoplastic elastomer composition according to claim 1, wherein the bulky rubber is a bulkyethylene-α-olefin copolymer rubber, or a bulkyethylene-α-olefin-non-conjugated diene copolymer rubber.

5. The process for producing a thermoplastic elastomer composition according to claim 1, where in the thermoplastic resin is an olefin polymer resin.
